(19) United States
(12) Patent Application Publication
(10) Pub. No.: US 2008/0065362 A1
(43) Pub. Date: Mar. 13, 2008

(54) Well completion modeling and management of well completion

(76) Inventors: Jim H. Lee, Houston, TX (US); Ted A. Long, Sugar Land, TX (US); Bruce A. Dale, Sugar Land, TX (US)

Correspondence Address: Exxon Mobil Upstream;Research Company, P.O. Box 2189, (CORP-URC-SW 359), Houston, TX, 77252-2189, US

(21) Appl. No.: 11/879,936

(22) Filed: Jul. 19, 2007

Related U.S. Application Data
(60) Provisional application No. 60/843,446, filed on Sep. 8, 2006.

(51) Int. Cl. G06G 7/48

(52) U.S. Cl. 703/10

(57) ABSTRACT

The present application describes a method and modeling system for managing and modeling well completions. The method includes constructing a wellbore model of a completion. Then, the wellbore model may be applied to generate one or more simulated production profiles, wherein the simulated production profiles include two or more of pressures associated to depth, temperatures associated to depth, flow rates associated to depth, fluid flow velocities associated to depth, and any combination thereof. The completion and one or more sensors may be disposed into a well. Sensory data may be acquired or obtained from the sensors associated with the completion. The sensory data is examined to determine if production conditions have changed. If the production conditions have changed, one or more measured production profiles are generated from the sensory data and are compared to the at least one simulated production profile to determine a modification to the completion. Then, the completion is modified based of the determination. However, if the production conditions have not changed, well operations continue.

### CROSS REFERENCE TO RELATED APPLICATIONS

This application claims the benefit of U.S. Provisional Application No. 60/843,446, filed Sep. 8, 2006.

### FIELD OF THE INVENTION

The present invention describes a method for managing and modeling wellbore completions to evaluate, analyze and assist in the production of hydrocarbons from subsurface formations. In particular, the present invention describes the application of computational fluid dynamics (CFD) modeling methods in analyzing and interpreting temperature, pressure, velocity and flow rate data measured on flow streams in wells, which may be used with real-time sensory data to enhance hydrocarbon recovery.

### BACKGROUND

This section is intended to introduce the reader to various aspects of art, which may be associated with exemplary embodiments of the present techniques, which are described and/or claimed below. This discussion is believed to be helpful in providing the reader with information to facilitate a better understanding of particular aspects of the present techniques. Accordingly, it should be understood that these statements are to be read in this light, and not necessarily as admissions of prior art.

The production of hydrocarbons, such as oil and gas, has been performed for numerous years. To produce these hydrocarbons, one or more wells in a field are typically drilled into a subterranean location, which is generally referred to as a subsurface formation or basin. Modeling techniques and processes are typically used to determine the location of the subsurface formation. Then, the process of producing hydrocarbons from the subsurface formation generally involves the use of various equipment and facilities to transport the hydrocarbons from the subsurface formation to delivery locations.

As part of the process of producing hydrocarbons, well surveillance may be performed to further enhance hydrocarbon recovery. Typically, reservoir and well surveillance methods rely upon surface production data and infrequent production logging trips performed only during shut-in or workover operations on a well-by-well basis. The conventional production logging tools (PLT) analysis methods rely on multiple types of log data and infer flow phenomena from a combination of pressure, spinner, and temperature logs. See McKinley, R. M. “Production Logging,” SPE 10035 presented at the International Petroleum Exhibition and Technical Symposium of the SPE, Beijing, China, March 1998. Consideration of the data can be time consuming and laborious, typically introducing (and requiring) significant subjectivity in the analysis. As a result, this approach may be especially difficult to extend to real-time data, particularly if only one property is measured (i.e., temperature, but not pressure, velocity or flow rate).

In contrast, a burgeoning array of fiber optic (F-O) technologies provide continuous acquisition of sensory data during both “normal” flowing operation as well as shut-in operations. For example, a well may include F-O technology for downhole sensing applications to provide real-time data on the wellbore environment. As the F-O technologies continue to improve in quality and reliability, additional applications for F-O technologies in downhole sensing applications having harsh pressure and temperature environments in the oil and gas industry have been developed. See Drakeley, B. K., et al., “In-well Optical Sensing—State-of-the-art Applications and Future Direction For Increasing Value In Production-Optimization Systems,” SPE 99696 presented at the SPE Intelligent Energy Conference, Amsterdam, The Netherlands, April 2006. For instance, F-O sensors may be deployed as components of “smart” or “intelligent” well completions to enable response automation or aid in actuation of wellbore equipment. In particular, a F-O distributed temperature sensing (DTS) system may be deployed in a well with commingled flow to detect changes in production (e.g., gas or water breakthrough), upon which a sliding sleeve or other shut-off device may be exercised to shut off production from an offending zone or interval.

However, despite increased installations of fiber optic instrumentation as a component in wellbore systems, automated remote administration of “smart” wells is still limited by several difficulties associated with implementation. These difficulties result from limitations in capabilities of systems to process and interpret sensory data. Although the sensory data may be recorded in real-time, it is processed as-needed on an indeterministic time basis. That is, interpretation of sensory data, such as F-O thermal data, may be difficult to evaluate and to infer downhole flow phenomena. As a result, manual intervention for actuation of “smart” features by an operator is still typically required.

Many efforts to solve this problem have focused on using multi-nodal models. See, e.g., Brown, G. A. et al, “Using Fibre-Optic Distributed Temperature Measurements to Provide Real-Time Reservoir Surveillance Data on Wytch Farm Field Horizontal Extended-Reach Wells,” SPE 62952 presented at the Annual SPE Technical Conference, Dallas, October 2000; Lanier, G. H., et al., “Brunei Field Trial of a Fibre Optic Distributed Temperature Sensor (DTS) System in a 1,000 m Open Hole Horizontal Oil Producer,” paper 84324 presented at the Annual SPE Technical Conference, Denver, October 2003; Ouyang, L. B. et al, “Flow Profiling Via Distributed Temperature Sensor (DTS) System—Expectation and Reality,” SPE Production & Operations, Vol. 21, pp. 269-281, 2006; Fryer, V., Shuxing, D., et al. “Monitoring Of Real-Time Temperature Profiles across Multizone Reservoirs During Production and Shut-In Periods Using Permanent Fiber-Optic Distributed Temperature Systems,” SPE 92962 presented at the SPE Asia Pacific Oil & Gas Conference, Jakarta, Indonesia, April 2005; and Brown, G. A., et al., “Production Monitoring Through Openhole Gravel-Pack Completions Using Permanently Installed Fiber-Optic Distributed Temperature Systems in the BP-operated Azeri Field in Azerbaijan,” paper SPE 95419 presented at the Annual SPE Technical Conference, Dallas, 2005. At each node, which each corresponds to a different depth, a description of the macro-structure of the well and the surrounding near-wellbore region is specified. Rock properties, fluid pressures, fluid temperatures, wellbore pressures, and wellbore diameters are typically specified. Pipe-flow correlations and simple energy balances may be used between nodes to combine the flow behavior at each node into a contiguous wellbore flow and thermal profile. The input parameters are then adjusted until a match with the measured thermal profile is obtained.

While these approaches have the advantage of simplicity and ease of calculation, there are several inherent assumptions that render these models inapplicable for modeling more complex wellbores. For instance, one of the assumptions is that unidirectional pipe flow correlations apply in between nodes. This assumption may be appropriate for wells with single reservoir depletion and simple commingled wells with no crossflow. That is, applications where a radially invariant temperature and flow rate may be assumed across the wellbore at any given axial depth. Further, single phase flow is also often assumed. For instance, some models assume a homogeneous mixture flow regime may be used to account for multi-phase oil/gas/water inflows. This assumption may not be appropriate for certain applications, such as deviated wells. In addition, energy balance accounts for radial heat transfer, but typically assumes negligible axial conductive heat transfer, which may only be appropriate for simple examples. Yet, this assumption fails to address axial heat transfer in the near-wellbore region, which is often ignored.

Given the above, a reasonable match between a multi-nodal model and a measured thermal profile may be obtained through iteration for any given time. However, even with the above noted assumptions, the uniqueness of the solution for a wellbore can not be guaranteed in these simplified models. For example, these assumptions may be inappropriate in wellbores with complex flow patterns, where a match at any single time interval may not result in a match at a later time interval if the physical couplings between the reservoir and wellbore are not honored, but only approximated. Thus, the non-uniqueness along with the sensitivity of the thermal profile to even small changes in production and data uncertainties in the formation and reservoir may severely limit the application of the multi-nodal approach in predictive anticipation of the thermal profile.

Accordingly, the need exists to predict the thermal profile under varying producing conditions. Further, the need exists for a method to facilitate rapid responses to changes in well production and improve diagnosis of flow behavior in the wellbore through the use of holistic models that incorporate both the macro-structure of the well and the surrounding near-wellbore region as well as the finer details of in-wellbore or downhole instrumentation (commonly referred to as “jewelry”), thereby accounting for the coupled effects these mechanical, geometrical, and chemical factors may have on the resulting flow profile.

### SUMMARY OF INVENTION

In one embodiment, a method of managing a well completion is described. The method comprises constructing a wellbore model of a completion; applying the wellbore model to generate at least one simulated production profile, wherein the at least one simulated production profile comprises at least two of pressures associated to depth, temperatures associated to depth, flow rates associated to depth, fluid flow velocities associated to depth, and any combination thereof; disposing the completion and at least one sensor into a well; obtaining sensory data from at least one sensor associated with the completion; examining the sensory data to determine if production conditions have changed; if the production conditions have changed, generating at least one measured production profile from the sensory data, comparing the at least one measured production profile to the at least one simulated production profile to determine a modification to the completion, and modifying the completion based of the determination; and if the production conditions have not changed, continuing to operate the well. The method may also comprise operating the well completion to produce hydrocarbons.

In another embodiment, a method of constructing a wellbore model is described. The method comprises constructing a geometrical representation of a wellbore completion comprising downhole instrumentation; discretizing the geometrical representation of the wellbore completion into a mesh representing the completion; populating the mesh with rock data; obtaining boundary conditions for the populated mesh to form the wellbore model; and simulating at least one production scenario with the wellbore model to create a simulated production profile.

In yet another embodiment, a modeling system for a wellbore completion is described. The modeling system includes a processor; a memory coupled to the processor; and a set of computer readable instructions accessible by the processor. The set of computer readable instructions are configured to construct a geometrical representation of a wellbore completion comprising downhole instrumentation; discretize the geometrical representation of the wellbore completion into a mesh representing the wellbore completion; populate the mesh with rock data; obtain boundary conditions for the populated mesh to form a wellbore model; and simulate at least one production scenario with the wellbore model to create a simulated production profile.

In one or more of the above embodiments, additional features may be present. For instance, the method may further comprise determining if the modification to the completion produces a desired response to the production conditions; reassessing the wellbore model and the sensory data if the modification does not produce the desired response to the production conditions; and/or operating the well to produce hydrocarbons from the well through the completion. Further, constructing the wellbore model may comprise constructing a geometrical representation of the completion comprising downhole instrumentation; discretizing the geometrical representation of the completion into a mesh representing the completion; populating the mesh with rock data; obtaining boundary conditions for the populated mesh to form the wellbore model; and simulating at least one production scenario with the wellbore model. The mesh may provide a framework to model countercurrent flow between an annulus and tubing in the completion. Also, in one or more embodiments, the method may further comprise solving energy and transport equations in each of a plurality of cells in the mesh. Also, the energy and transport equations, which may include Navier-Stokes equations, may model at least one of radial convective heat transfer, radial conductive heat transfer, axial convective heat transfer, axial conductive heat transfer and fluid flow within the well along with a region surrounding the well. The rock data is based on at least one of geologic model data, log data and any combination thereof. The method may also include comparing the rock data within the mesh with at least one of geologic model data, log data and any combination thereof; wherein the boundary conditions are based on at least one of well test data, modular dynamic tester data, reservoir simulator data and any combination thereof; comparing the boundary conditions within the wellbore model to at least one of well test data, modular dynamic tester data, reservoir simulator data and any combination thereof; generating type curve analogues from the simulations of the at least one production scenario with the wellbore model; wherein the at least one sensor comprises fiber optic distributed temperature sensors; wherein the at least one sensor are part of a permanent downhole monitoring system; wherein the at least one sensor comprises at least one of fiber optic pressure sensors, fiber optic temperature sensors, and fiber optic flow sensors; wherein the at least one simulated production profile is generated prior to obtaining the sensory data; wherein the downhole instrumentation of the completion modeled by the constructed model results in radial variations of the pressures associated to depth, temperatures associated to depth, flow rates associated to depth and fluid flow velocities associated to depth.

### BRIEF DESCRIPTION OF THE DRAWINGS

The foregoing and other advantages of the present technique may become apparent upon reading the following detailed description and upon reference to the drawings in which:

FIG. 1 is an exemplary flow chart of a process for operating a wellbore with forward modeling and sensory data in accordance with certain aspects of the present techniques;

FIG. 2 is an exemplary flow chart of forward modeling of FIG. 1 in accordance with certain aspects of the present techniques;

FIG. 3 is an exemplary wellbore in accordance with certain aspects of the present techniques; and

FIGS. 4A-4B are exemplary screen views of the wellbore completion modeling in accordance with some aspects of the present techniques.

### DETAILED DESCRIPTION

In the following detailed description, the specific embodiments of the present invention will be described in connection with its preferred embodiments. However, to the extent that the following description is specific to a particular embodiment or a particular use of the present invention, this is intended to be illustrative only and merely provides a concise description of the exemplary embodiments. Accordingly, the invention is not limited to the specific embodiments described below, but rather, the invention includes all alternatives, modifications, and equivalents falling within the true scope of the appended claims.

The present technique is directed to a method for managing and modeling wellbore completions to evaluate, analyze and assist in the production of hydrocarbons from subsurface formations. In particular, the present techniques describe the application of computational fluid dynamics (CFD) modeling methods in analyzing and interpreting temperature, pressure, and flow data measured on water, oil, liquid and/or gas flowstreams in wells, which may be used with real-time data to enhance hydrocarbon recovery. The present techniques may be utilized to predict the thermal profile under varying producing conditions. Further, the methods described herein may facilitate rapid responses to changes in well production and improve diagnosis of flow behavior in the wellbore through the use of holistic models that incorporate the macro-structure of the well and the surrounding near-wellbore region (e.g. region surrounding the well) as well as the finer details of in-wellbore instrumentation, thereby accounting for the coupled effects these mechanical, geometrical, and chemical factors may have on the resulting flow profile. The modeling may be used both for design of new wells (e.g. for uncertainty analysis) and production history matching of existing wells (e.g. for reservoir evaluation and forward modeling comparison with sensory data).

For instance, under the present techniques, a method and apparatus to evaluate the temperature and flow characteristics in complex well completions is described. In this method, the Wellbore completion, including both the inner wellbore instrumentation as well as the surrounding near wellbore region, may be discretized into a two-dimensional or three-dimensional computer model of the wellbore completion. The resulting mesh may include valves or tubing geometry that result in countercurrent flow between the annulus and tubing. Axial and radial resolution in the model may be user defined by varying the fineness or coarseness in the mesh. Navier-Stokes equations of fluid dynamics, which nodal correlations only approximate, may then be solved in each cell of the mesh. Also, energy equations may account for convective and conductive heat transfer both radially as well as axially in both the wellbore as well as the surrounding near wellbore region.

Further, the present techniques provide a process to manipulate and utilize real-time data from permanent downhole monitoring (PDM) systems, which may include fiber optic (F-O) pressure, temperature, velocity and/or flow sensors. These interpretative methods are centered upon detailed computational fluid dynamics (CFD) simulations of the wellbore and surrounding near-wellbore region. That is, in addition to complex geometric flow dependencies, the CFD model facilitates solution of the highly coupled physics present in multi-phase systems, such as gas compressibility effects that impact heat transfer and the thermal profile of the wellbore. In the near-wellbore region, log derived reservoir permeabilities and porosities are honored and used to populate the CFD model of the wellbore completion. By running the CFD model for different anticipated production scenarios, a series of thermal “type curves” can be generated that can be used to “predict” the time-dependent flow, pressure, and/or thermal profiles recorded by the PDM system. These may be used to assess the utility of a thermal sensor in light of anticipated reservoir and wellbore behavior or reduce the time involved for post-measurement analysis for real-time sensory data.

In contrast to other approaches, the “forward modeling” involves obtaining initial production profiles to predictively and proactively assess the form of a flow, pressure, velocity and/or thermal profile. Other approaches, such as multi-nodal approaches, may be suited for taking measured flow or thermal profiles and matching the profiles by adjustment of a plurality of wellbore or reservoir parameters. For instance, with other approaches, such as an “inverse modeling” approach, limited reservoir or formation data from well logs or well tests may be the only data available and utilized in the analysis. Yet, with continuous well surveillance, well-developed characterizations of fluid properties and reservoir properties may be utilized to constrain and enhance the input parameters of the wellbore inflow models with the present techniques. That is, the present techniques, which may be correlated to reservoir simulation data, may predictively assess the impact of reservoir depletion on fluid properties and wellbore drawdown, and thus, the ensuing flow rate, pressure, velocity and thermal profiles in the wellbore.

In particular, with complex completions, such as those with commingled or countercurrent flows in opposite directions in the tubing and annulus, other approaches may not account for variations within the wellbore, rendering interpretation of sensory data inaccurate. While other approaches may be adequate for simple completions (e.g. single contributing inflow zone and unidirectional flow), they may fail when applied to systems where flow and thermal profiles show significant radial variation within the wellbore. Indeed, the pipe flow correlations used between nodes in typical multi-nodal approaches only approximate the Navier-Stokes solutions, and may not be applicable in some of the complex completions described above. However, these variations may result from unique flow patterns around valves, chokes, sleeves, and other downhole instrumentation, or from countercurrent heat exchange between the tubing and annulus, for example. Accordingly, the use of CFD modeling may provide a numerical solution to the full set of Navier-Stokes equations of fluid dynamics, which are an exact characterization of the flow behavior.

Generally, CFD modeling is not utilized for flow through a wellbore and the surrounding near wellbore region. While CFD may be applied to short length/scale studies, such as flow around a valve or foil, or development of turbulent eddies and their attachment and detachment to walls, the CFD modeling is considered to be too computational expensive for other applications. As such, the long asymmetry of deep wells is not typically an application of CFD modeling. However, as noted above, the use of the CFD modeling and coupling of a porous media model of the reservoir to a wellbore model, wherein the full Navier-Stokes equations are solved, is beneficial and may enhance well operations.

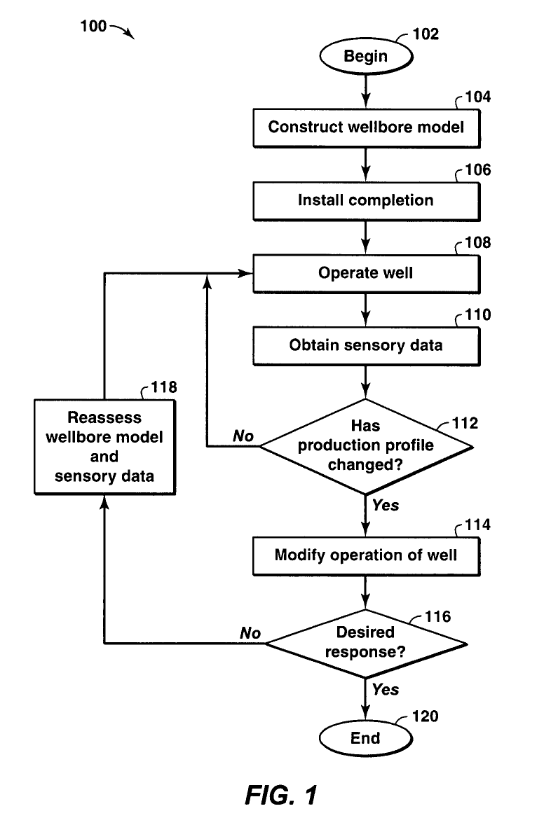

Turning now to the drawings, and referring initially to FIG. 1, an exemplary flow chart 100 of a process for operating a wellbore utilizing forward modeling and sensory data in accordance with certain aspects of the present techniques is described. In this process, “forward modeling” is utilized to predictively and proactively assess the form of a flow rate, pressure, velocity and/or thermal profiles. The wellbore model may be generated to account for the radial extent of the near-wellbore region and may be modeled from a few feet to hundreds of feet as required. While operating the completion, the wellbore model simulation results (e.g. simulated production profiles) may be utilized with sensory data to determine if the measured production profile has changed and if the wellbore completion should be modified.

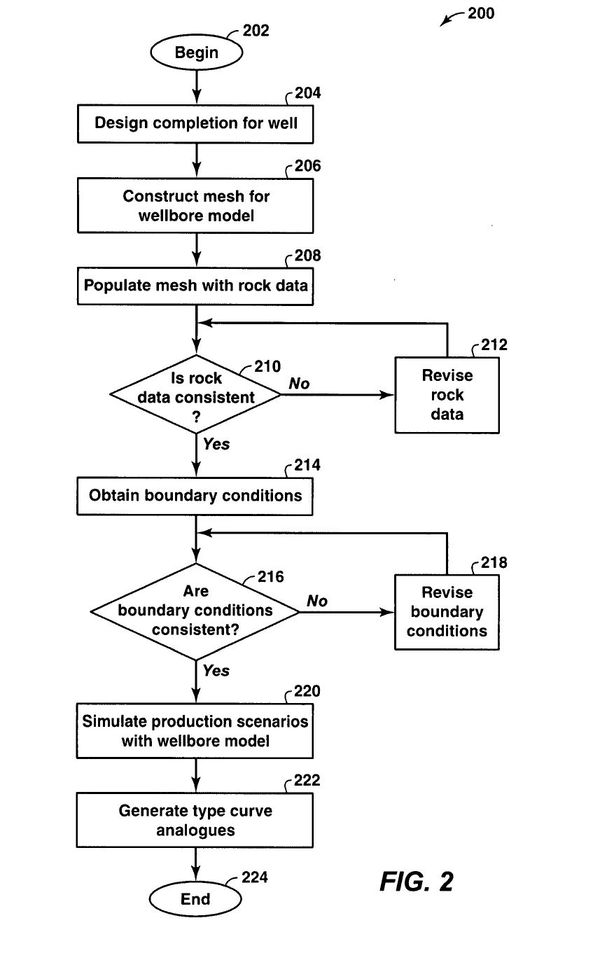

The flow chart begins at block 102. At block 104, a wellbore model may be constructed. The construction of the wellbore model may include designing a wellbore completion for a well. This process, which is described further in FIG. 2, may involve discretizing and meshing a geometrical representation of the wellbore completion at a resolution fine enough to capture the details of a simulated production profile. The simulated production profile may include pressures associated to depth, temperatures associated to depth, flow rates associated to depth, fluid flow velocities associated to depth, and any combination thereof. The wellbore model may be created on a modeling system that includes modeling instructions or applications, such as CFD modeling software or other suitable modeling software. In particular, CFD modeling software may include FLUENT by Fluent Inc, and/or CFX by Ansys, Inc., for example. Then, the completion may be installed, as shown in block 106. The installation of the completion may include ordering the completion equipment, assembling the equipment, transporting the equipment to the well site, placing the equipment within the wellbore and performing tests on the equipment. The completion equipment may include tubing, packers, mandrels, valves, control lines, perforations, sand screens, and the like.

Once the completion is installed, the well operations may be performed as shown in blocks 108-118. At block 108, the well is operated. The operation of the well may involve operating the well based on the analysis of the wellbore model to produce hydrocarbons from a subsurface formation. At block 110, sensory data may be obtained from measurement devices, such as sensors, gauges and/or meters, within the well. The measurement devices may include fiber optic (F-O) distributed temperature sensing (DTS) system that may be strapped to portions of the completion, F-O sensors that collect thermal data, flow rate data, velocity data, pressure data, and the like. The sensory data may include data collected over a specific period of time. The sensory data may then be examined to determine if production conditions have changed. The production conditions may include reservoir pressures, bottom hole pressures, drawdown and the like, as is known by those skilled in the art. If the production conditions have changed, then a measured production profile may be generated from the sensory data. The measured production profile, which includes sensory data may be formatted similar to the simulated production profile, may include sensory data of pressures associated to depth, temperatures associated to depth, flow rates associated to depth, fluid flow velocities associated to depth, and any combination thereof. Then, a determination is made whether the production profile has changed, as shown in block 112. The determination may include comparing the measured production profile to the one of the simulated production profiles to determine whether a modification should be made to the completion. This determination may be based on experience or specific thresholds set for operating the well. If the measured production profile has not changed, the well may continue to be operated as discussed in block 110.

However, if the production profile has changed, the well operation may be modified as shown in block 114. The modification of the well operation may include adjusting or exercising downhole or completion equipment, such as exercising a valve, adjusting the location or completion equipment, and shutting the well for reconfiguration of the completion, for example. At block 116, a determination is made whether the modification provided the desired response. The desired response may be to reduce water intake by the completion, or another action to maintain production or enhance well operations. If the desired response is not produced, the wellbore model and sensory data may be reassessed, as shown in block 118. The reassessment may include re-evaluating the wellbore model inputs (e.g. rock data and boundary conditions) and simulating additional simulation production profiles based on the revised wellbore model. Then, the well may be operated as discussed in block 110. However, if the desired response is produced, the process may continue by revising the stimulated production profiles with the sensory data, maintain the simulated production profiles without revision, and/or the process may end, as shown in block 120.

Beneficially, the present techniques may be utilized to reduce the time utilized to response to changes in production conditions. To facilitate these changes, the simulated and measured production profiles may be used to provide a better understanding of the well's performance and guide personnel in reviewing the sensory data.

In FIG. 2, an exemplary flow chart 200 of forward modeling of FIG. 1 in accordance with certain aspects of the present techniques is described. In particular, this process may evaluate the pressure, temperature, velocity and/or flow characteristics in complex well completions. In this process, the entire completion interval or a portion of the completion interval, including both the inner wellbore instrumentation (e.g. downhole instrumentation) as well as the surrounding near-wellbore region, may be modeled by discretization into a two-dimensional or three-dimensional computer model. The resulting mesh may include valves or tubing geometry that model countercurrent flow between the annulus and tubing. The full set of Navier-Stokes equations of fluid dynamics, which nodal correlations only approximate, may then be solved in each cell of the mesh. The energy equations account for convective and conductive heat transfer both radially and axially in both the wellbore and surrounding near-wellbore region.

The flow chart begins at block 202. At block 204, a design of a completion for a well is created. The design may be a computer model of the wellbore geometry created using a well schematic or completion design as a basis. The computer model may include both the macro-scale geometry of the casing and tubing dimensions, as well as the details of the downhole instrumentation, such as packers, mandrels, valves, control lines, and perforations. Then, the mesh for the wellbore model may be constructed in block 206. The construction of the mesh for the wellbore model may include discretizing and meshing the geometrical representation of the wellbore completion at a resolution fine enough to capture the details of the flow profile. The level of resolution may vary from several feet of tubing in the axial direction to a few inches or less around perforations, valves, and orifices where turbulent eddy effects may be expected to impact the local flow characteristics or induce pressure losses. Coupled to the wellbore is the surrounding near-wellbore region, modeled as a porous medium. The radial extent of the near-wellbore region may be modeled from a few feet to hundreds of feet as required. The radial extent may be adjusted by varying the mesh geometry and resolution within the wellbore and near wellbore regions. If the wellbore model is a CFD model, the creation and solution of the CFD model of the wellbore and surrounding near-wellbore region may be accomplished through the use of available codes and algorithms, such as FLUENT and CFX, for solving the Navier-Stokes equations, which may also include solver algorithms for coupled nonlinear equations. Furthermore, historical visualization and mesh creation may be mitigated by development of graphical user interfaces for pre-processing and computer-aided design (CAD) software that semi-automate mesh creation for CFD applications, such as GAMBIT by Fluent, Inc. Any number of these CAD/CFD software packages may be sufficient to replicate the inner instrumentation of the wellbore. Although computational power limitations are mitigated by ever-increasing advances in processor technology, numerical solution of the Navier-Stokes equations over the long length scales of completion intervals (e.g. hundreds to thousands of feet) may still involve access to significant computational resources. As a result, the resolution may be limited by the simulation time required for different scales of resolution.

Once constructed, the mesh may be populated with rock data, as shown in block 208. The rock data may be specified manually in modeling software or stored in a computer readable data file. Once the mesh is populated, a determination is made whether the rock data is consistent with other rock data, as shown in block 210. In populating the near-wellbore region of the wellbore model, input properties for the porous medium may be derived from geological characterization of log data and/or geological modeling data. In the absence of log data, well test data can also be used albeit with some loss of resolution. Regardless, the ability to populate each cell of the mesh with permeability, porosity, and conductivity data enables heterogeneities in the data and their impact on flow to be honored. If the rock data is not consistent, the mesh of the wellbore model may be revised based on the obtained rock data, as shown in block 212.

However, if the rock data is consistent, the boundary conditions may be obtained in block 214. For instance, the reservoir pay zones, which include hydrocarbons, may be defined in the near-wellbore region. Sandstone formations, shale layers may be explicitly modeled as impermeable flow boundaries (e.g. axial heat transfer is still allowed). Varying degrees of formation connectivity may be specified for carbonates. Fluid pressure, temperature, and compositional boundary conditions are specified for each pay zone at the radial extent of the near-wellbore region. These may be specified with simple linearized functions or more complicated depth-correlated relationships, depending on the reservoir. At block 216, a determination is made whether the boundary conditions are consistent. To determine if the boundary conditions are consistent, the wellbore model may be compared to reservoir simulator, modular dynamic tester data and/or well tests. For example, the pressure and temperature boundary conditions may be updated from a reservoir simulator to account for changes in production with time. Fluid compositions are varied to match the evolution in gas-oil ratio and water cut with production changes, such as coning or water flood encroachment. If the boundary conditions are not consistent, the boundary conditions may be revised based on the obtained boundary conditions, as shown in block 218.

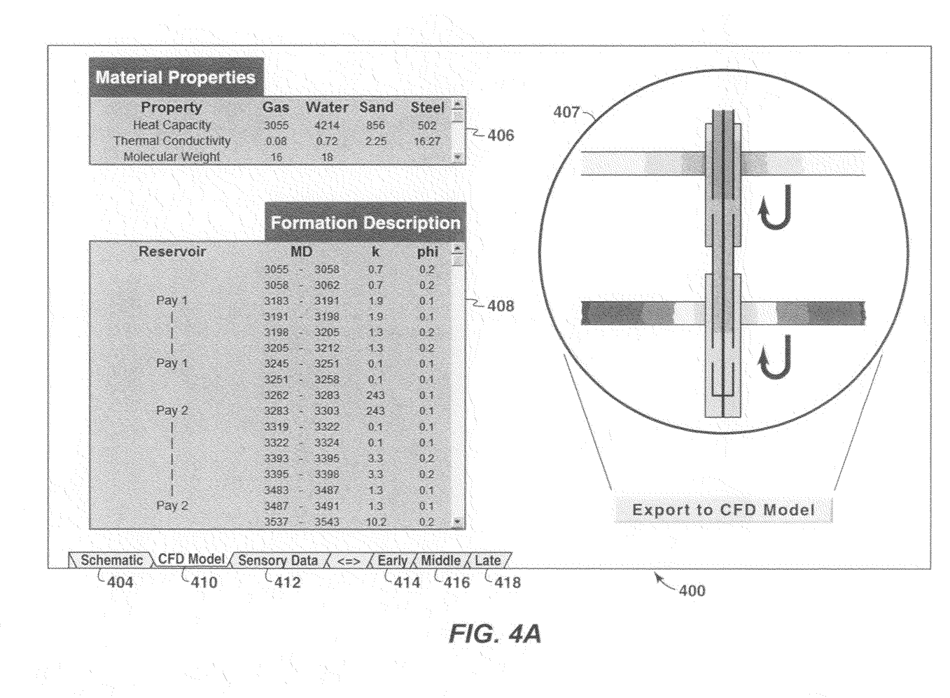

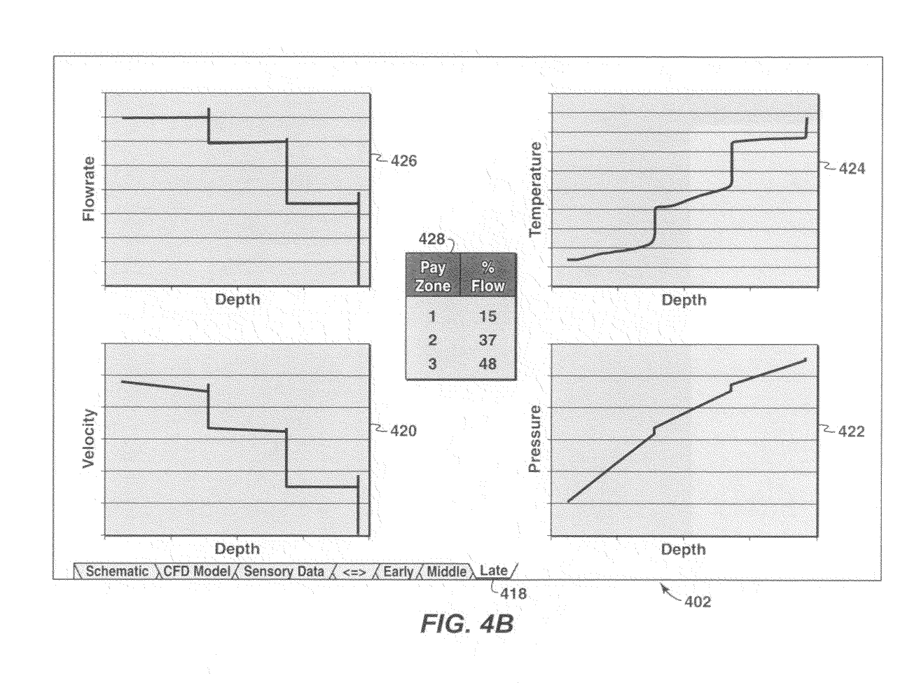

If the boundary conditions are consistent, production scenarios with the wellbore model may be simulated, as shown in block 220. The simulations may generate various type curve analogues, which are shown in greater detail in FIG. 4B. The type curve analogues may include flow rates, pressures, temperatures and velocity data for the wellbore at certain depths. Regardless, the process ends at block 222.

Beneficially, the use of rock data (from log data and/or geological modeling data) and reservoir data (from well test data, modular dynamic tester data, and/or reservoir simulator data) to constrain the input values into the wellbore model provides an advantage for applying the CFD model predictively through time. The reservoir simulator data provides an expectation of reservoir performance that can be correlated with well performance to support the model results. Preferably deployed as representative “type curves,” forward modeling forecasts of simulated production profiles for wellbore flow rates, pressures, velocities and thermal profiles provides operation personnel with an understanding of the predicted evolution of the production profile.

Further, by having a qualitative understanding of how the shape of the flow, pressure, velocity and/or thermal profile correlates with anticipated production scenarios, the potentially time-consuming process of post-measurement analysis of data may be circumvented. For instance, the inverse modeling approach first requires acquisition of data, then a certain amount of lag-time for interpretation. This lag-time may be further lengthened with iterative discussions between personnel operating and personnel servicing the well. The forward modeling of the present techniques may enhance operations by reducing response time in the field in comparison to other approaches, such as the inverse modeling approach. These changes may include determining that a change in the thermal profile is due to water onset and deciding to exercise a sliding sleeve to shut off water production from a specific zone. If, however, a measured pressure, thermal, velocity or flow profile is anticipated by a characteristic type curve analogue, even a rough onsite correlation may prove sufficient to progress an operating decision or response. Optimally, these two approaches complement each other to provide enhanced well performance with minimal downtime.

Moreover, the use of the present techniques may utilize CFD methods to provide detailed and qualitative data on velocity, flow rates, temperature and pressure gradients/profiles along the wellbore and downhole instrumentation. As noted above, CFD methods have typically been applied to short length scale studies, such as flow around a valve or foil, or attachment and detachment of turbulent eddies to walls because of computational expense. The use of CFD models with the long asymmetry of deep wells is generally not utilized because of the computational resources. However, coupling a porous media model of the reservoir with a wellbore model having Navier-Stokes equations provides heat transfer aspects of the wellbore.

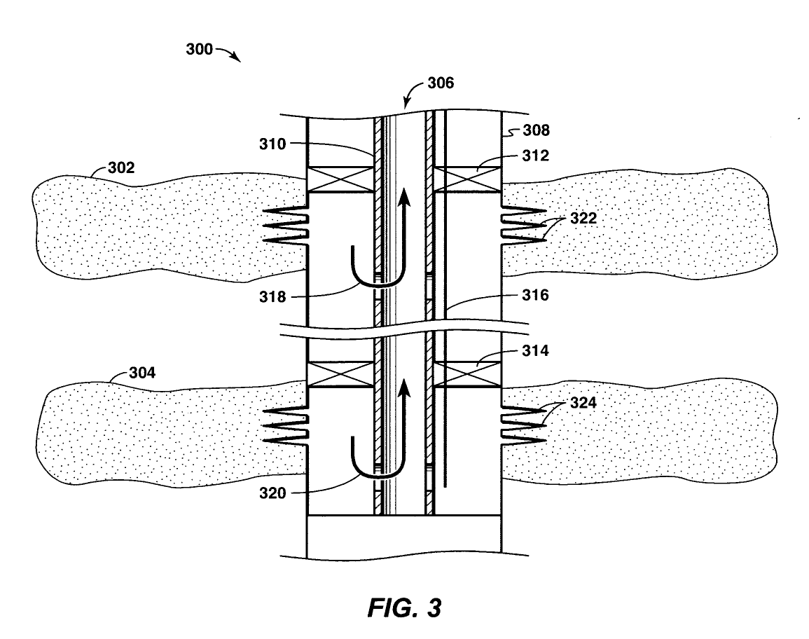

As an example, FIG. 3 is an exemplary partial view of a well in accordance with certain aspects of the present techniques. In this partial view, the well 300, which is associated with a tree (not shown) and surface facility (not shown), accesses production zones 302 and 304 of a subsurface formation via a wellbore 306. The wellbore 306 may include tubing, such as casing string 308 and production tubing string 310. The completion within the wellbore 306 may also include packers 312 and 314 and a fiber optic DTS system 316. Perforations 322 and 324 may be formed in the casing string 308 and utilized with the packers 312 and 314 to provide fluid flow paths 318 and 320 from the production zones 302 and 304 into openings in the production tubing string 310. The use and operation the equipment utilized in the wellbore completion is known to those skilled in the art.

In this example, the thermal profile of the wellbore 306 is characterized by the fluid flow paths 318 and 320 being a countercurrent flow. These fluid flow paths 318 and 320 flow down the annulus formed between the casing string 308 and production tubing string 310 and up through openings in the production tubing string 310. As a result, radial heat is transferred across the production tubing string 310. A nodal approach is not amenable to analysis of the radial temperature distribution across the wellbore 306 because the localized heat transfer coefficient varies with flow rate, time and space. Thus, countercurrent heat exchange renders interpretation of a fiber optic temperature sensor strapped to the outside of the tubing extremely difficult.

Analysis of the above countercurrent flow may be further complicated if the flow profile (e.g. fluid flow paths 318 and 320) is impacted by valves, packers, or other equipment used to control or isolate production. Additional complexities result if the production fluid is commingled from multiple pay zones, or if multi-phasic interactions between gas, condensate, and water are present. Using a single phase mixture with a single set of averaged bulk properties is unsatisfactory if the fiber optic DTS system 316 is intended to thermally monitor for the onset of gas or water production. Thus, if a two-phase gas-water system is modeled, single phase gas simulations may be performed for the cases of “early” and “middle” life production when water is not present.

As another example, thermal profiles for a gas well may be simulated using a CFD model encompassing 1,800 feet of the wellbore associated with a completion interval. The completion may include downhole inflow valves and packers along with perforated intervals, which are incorporated into the mesh of the wellbore model. The perforated intervals may be modeled as an open hole basis for a first approximation. An assumed geothermal gradient may be used as the temperature boundary condition. Further, the solutions of the transport equations, such as Navier-Stokes equations, and energy equations may provide a quantitative characterization of the pressure, temperature, and velocity profiles within the wellbore. If a F-O DTS system is assumed to be strapped to the tubing of the completion, profile contours may be generated at different radial positions within the wellbore to examine the impact of fiber placement.

In addition to anticipating changes in the thermal profile over the entire completion interval or a portion of the completion interval, the simulations of the wellbore model may also indicate that water breakthrough in lower production intervals or zones may impact flow rates in upper production intervals or zones because of changes in fluid density and wellbore hydraulics. As a result, the simulation data may be used to enhance design of the completion, to optimize fiber placement outside the tubing, and/or to combine with sensory data in an operational well to proactively provide insight into potential problems.

Although the example above pertains specifically to analysis of fiber optic thermal data, the general applicability of the process may be applied to a variety of other approaches because transport equations are solved in addition to the energy equation. That is, the flow and pressure profiles may be determined, as well. Ultimately, as confidence in a match between simulation and measured data increases, the CFD simulation results may be used to allocate zonal contributions to flow. Additionally, the simulations may also be used to evaluate short-term flow conditions, such as those resulting from stimulation and cleanup operations.

Despite the complexity in creating CFD models to capture the underlying physics of the reservoir and wellbore, the results of the simulations may be deployed in an efficient manner. For example, the processes described above may be implemented in a modeling system. Different elements and components of the modeling system may be utilized to display and provide the results of the simulations (e.g. simulated production profiles). The modeling system may include a processor, one or more applications or set of computer readable instructions, data and memory. As an example, the modeling system may include computers, servers, databases and/or a combination of these types of systems, which may also include monitors, keyboards, mouses and other user interfaces for interacting with a user. The applications or set of computer readable instructions may include the modeling software or code configured to perform the methods described above, while the data may include reservoir data, sensory data, simulation data, or other information utilized in the methods described above. Of course, the memory may be any conventional type of computer readable storage used for storing applications, which may include hard disk drives, floppy disks, CD-ROMs and other optical media, magnetic tape, and the like.

Further, because the modeling system may be utilized to communicate with other devices, such as tools associated with the wellbore, the modeling system may include one or more communication components that exchange data with devices located in different geographic locations, such as different offices, buildings, cities, or countries. The network, which may include different devices, such as routers, switches, bridges, for example, may include one or more local area networks, wide area networks, server area networks, or metropolitan area networks, or combination of these different types of networks. The connectivity and use of the network by the devices and the modeling system is understood by those skilled in the art.

As an example of the use of the present techniques, a completion may be constructed and modeled for CFD simulations. These CFD simulations may relate to a completion that is designed, modeled, completed and installed for a well. As the well is operated to produce hydrocarbons, sensory data acquisition may be performed by a F-O sensing system that is installed partially within the wellbore. The F-O sensing system may be used to detect a change in the temperature, pressure, or flow profile, which may be due to onset of water production. From the sensory data, personnel may infer factors associated with the observed changes in sensory data by comparing and/or matching the measured temperature, pressure, or flow profile to one of those given in the wellbore model. From this comparison, the personnel may enact a response to the change in production by closing a valve, initiating a workover, reducing drawdown, and/or other suitable modifications to the well. Then, the personnel may perform a more rigorous post-response evaluation of the sensory data to affirm the understanding that the response or modification to the completion is appropriate. Feedback may also be provided to revise and further calibrate the CFD model to improve the forward modeling and prediction for real-time sensory data.

To operate the modeling system, an end user may run the modeling application via graphical user interfaces (GUIs), which are provided in various screen views discussed below in FIGS. 4A-4B. Via the screen views or through direct interaction, a user may launch the modeling to perform the methods described above. For example, in the basic form, flow rate, pressure, or thermal type curve analogues may be generated for various unique production scenarios to establish baselines for comparison. These curve analogues may be graphically tabulated or correlated to different production events. Specifically in this example, three different thermal profiles may be generated to represent “early,” “middle,” and “late” life corresponding to low pressure drawdown, high pressure drawdown, and high pressure drawdown with water incursion (e.g. multi-phase flow dynamics). Screen views of such an example tool are provided in FIGS. 4A-4B.

FIGS. 4A-4B are exemplary screen views 400 and 402 of the wellbore modeling in accordance with some aspects of the present techniques. The screen view 400 is an exemplary view of a GUI that includes various windows and tabs associated with other screen views, such as screen view 402 of FIG. 4B. In the screen view associated with tab 404, which is labeled “Schematic Menu,” details of the well hardware and instrumentation is provided. This data, which is shown in windows 406-408 and associated with the well of FIG. 3, may be used to identify instrumentation and/or hardware equipment that may constrict or impact flow paths and profiles with the wellbore for the completion. It should be noted that the different hardware may be implemented into the geometry of the CFD mesh.

On another tab 410, which is labeled “CFD Model,” fluid phases and properties are specified. Material properties of the hardware (e.g. equipment modeled as steel or other composite materials) and rock are also given because these material properties may impact axial and radial heat transfer of the CFD model. A user-specified formation description may also include rock properties (e.g., permeability, porosity) in the near wellbore region. These rock properties or rock data may also be validated or derived from log data and any geologic models of the formation, as noted above. Further, pay locations (e.g. production zones having hydrocarbons) are also specified as flow entry zones. When complete, these properties, which include fluid and reservoir properties, are formatted into a format utilized by the CFD model (e.g. wellbore model created in the CFD modeling system).

On yet another tab 412, which is labeled “Sensory Data,” F-O sensory data may displayed in this menu. This screen view may include some data filtering capabilities to process the data with respect to time, depth, and frequency. The filtered data and sensory data may be used for visual comparison against the CFD simulations shown in the Early, Middle, and Late life tabs, describe below.

For the tabs 414, 416 and 418 which are labeled “Early,” “Middle” and “Late,” the CFD simulations of the wellbore at different stages of well life are provided. Early life typically corresponds to reservoir pressures and relative permeabilities at initial completion, when the well is initially operated. Middle life may correspond to reservoir pressure and relative permeabilities after some prolonged period of production, and may reflect workover or changes to the well completion, such as abandoned/inactive perforations and depleted pay zones. Late life may reflect low reservoir pressures after prolonged field depletion, and the potential impact of water or gas breakthrough on the production profile of the well.

In each screen views associated with the tabs 416-418, contours of the pressure, flow rate, axial velocity, and temperature profiles as taken from the CFD simulation and plotted for visual reference. This data that may presented as type curve analogues in that, like type curves, provide graphical images of the data to assist in interpretation of wellbore behavior. An example of the “Late” tab 418 is shown in greater detail in the screen view 402 of FIG. 4B. In the screen view 402, various windows 420, 422, 424, 426 and 428 provide graphical representations of portions of the simulated production profiles, such as pressures associated to depth, temperatures associated to depth, flow rates associated to depth, fluid flow velocities associated to depth, and any combination. As such, personnel, which may be located at the well or responsible for managing the well, may review the type curve analogues to understand and anticipate the pressure and temperature profiles that may be recorded or measured by a real-time F-O sensing system. Correspondence of a change in shape of the production profile to that provided by CFD simulation provides support for inferences about the flow behavior, as the flow rate and velocity profiles that correspond to the pressure and temperature type curve analogues are provided in this screen view 402. It is this early anticipation and understanding of the wellbore flow dynamics that enables rapid responses to production changes to reduce delays in responding to well events. As additional data is collected, the data may be utilized to assist in revision and enhanced calibration of the CFD model.

Further, it should be noted that while the present techniques described above provide examples of the analysis of fiber optic thermal sensory data, this sensory data is provided only as an example and does not limit the application of the present techniques. For example, forward modeling may be utilized to optimize placement of the fiber optic sensor by predicting flow profiles as a function of the radial position in the wellbore and to design complex completions by accounting for geometrical impacts to flow. Further, other examples may include simulating clean-up operations and/or stimulation operations.

Accordingly, holistic CFD modeling of the wellbore and near-wellbore region is useful for evaluating complex flow paths and heat transfer. Axial and radial dependencies can be probed to optimize wellbore completion design, and sensitivities may be run to forecast the impact of production changes and production profiles. The enhancements in both computational speed and grid resolution may improve application of CFD modeling to the design of new wells and production history matching for existing wells.

Further, for real-time asset management, the high data sampling frequency and automated response associated with the wellbore models may enhance evaluation of desired response to production targets. Deployment of CFD simulation results as type curve analogues may further enhance well operations by facilitating rapid responses to changes in well production and production profiles, while reducing post-measurement analysis time. This type of application may be particularly beneficial for well completions that utilize F-O sensors. As such, the above described processes provide a mechanism to evaluate pressure, temperature, and/or flow profiles within the wellbore to assist interpretation.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

What is claimed is:

1. A method of managing a well completion comprising:
constructing a wellbore model of a completion;
applying the wellbore model to generate at least one simulated production profile, wherein the at least one simulated production profile comprises at least two of pressures associated to depth, temperatures associated to depth, flow rates associated to depth, fluid flow velocities associated to depth, and any combination thereof;
disposing the completion and at least one sensor into a well;
obtaining sensory data from at least one sensor associated with the completion;
examining the sensory data to determine if production conditions have changed;
if the production conditions have changed, generating at least one measured production profile from the sensory data, comparing the at least one measured production profile to the at least one simulated production profile to determine a modification to the completion, and modifying the completion based of the determination; and
if the production conditions have not changed, continuing to operate the well.

2. The method of claim 1 further comprising determining if the modification to the completion produces a desired response to the production conditions.

3. The method of claim 1 further comprising reassessing the wellbore model and the sensory data if the modification does not produce the desired response to the production conditions.

4. The method of claim 1 wherein constructing the wellbore model comprises:
constructing a geometrical representation of the completion comprising downhole instrumentation;
discretizing the geometrical representation of the completion into a mesh representing the completion;
populating the mesh with rock data; and
obtaining boundary conditions for the populated mesh to form the wellbore model.

5. The method of claim 4 wherein the mesh provides a framework to model countercurrent flow between an annulus and tubing in the completion.

6. The method of claim 4 further comprising solving energy and transport equations in each of a plurality of cells in the mesh.

7. The method of claim 6 wherein the energy and transport equations model at least one of radial convective heat transfer, radial conductive heat transfer, axial convective heat transfer, axial conductive heat transfer and fluid flow within the well along with a region surrounding the well.

8. The method of claim 7 wherein the energy and transport equations comprise Navier-Stokes equations.

9. The method of claim 4 wherein the rock data is based on at least one of geologic model data, log data and any combination thereof.

10. The method of claim 4 further comprising comparing the rock data within the mesh with at least one of geologic model data, log data and any combination thereof.

11. The method of claim 4 wherein the boundary conditions are based on at least one of well test data, modular dynamic tester data, reservoir simulator data and any combination thereof.

12. The method of claim 4 further comprising comparing the boundary conditions within the wellbore model to at least one of well test data, modular dynamic tester data, reservoir simulator data and any combination thereof.

13. The method of claim 4 further comprising generating type curve analogues from the simulations of the at least one production scenario with the wellbore model.

14. The method of claim 1, wherein the at least one sensor comprises fiber optic distributed temperature sensors.

15. The method of claim 1, wherein the at least one sensor are part of a permanent downhole monitoring system.

16. The method of claim 1, wherein the at least one sensor comprises at least one of fiber optic pressure sensors, fiber optic temperature sensors, and fiber optic flow sensors.

17. The method of claim 1 wherein the at least one simulated production profile is generated prior to obtaining the sensory data.

18. The method of claim 1 wherein the downhole instrumentation of the completion modeled by the constructed model results in radial variations of the pressures associated to depth, temperatures associated to depth, flow rates associated to depth and fluid flow velocities associated to depth.

19. The method of claim 1, further comprising operating the well to produce hydrocarbons from the well through the completion.

20. The method of claim 1 wherein the constructed model is based on computational fluid dynamics modeling of the well and a region surrounding the well.

21. A method of producing hydrocarbons comprising:
constructing a wellbore model of a completion;
applying the wellbore model to generate at least one simulated production profile, wherein the at least one simulated production profile comprises at least two of pressures associated to depth, temperatures associated to depth, flow rates associated to depth, fluid flow velocities associated to depth, and any combination thereof;
disposing the completion and at least one sensor into a well;
operating the completion to produce hydrocarbons from a subsurface formation accessed by the wellbore;
obtaining sensory data from at least one sensor associated with the completion;
examining the sensory data to determine if production conditions have changed;
if the production conditions have changed, generating at least one measured production profile from the sensory data, comparing the at least one measured production profile to the at least one simulated production profile to determine a modification to the completion, and modifying the completion based of the determination; and
if the production conditions have not changed, continuing to operate the well.

22. A method of constructing a wellbore model comprising:
constructing a geometrical representation of a wellbore completion comprising downhole instrumentation;
discretizing the geometrical representation of the wellbore completion into a mesh representing the wellbore completion;
populating the mesh with rock data;
obtaining boundary conditions for the populated mesh to form a wellbore model; and
simulating at least one production scenario with the wellbore model to create a simulated production profile.

23. The method of claim 22 wherein the mesh provides a framework to model countercurrent flow between an annulus and tubing in the completion.

24. The method of claim 22 further comprising solving energy and transport equations in each of a plurality of cells in the mesh.

25. The method of claim 24 wherein the energy and transport equations model at least one of radial convective heat transfer, radial conductive heat transfer, axial convective heat transfer, axial conductive heat transfer and fluid flow within the well along with a region surrounding the well.

26. The method of claim 24 wherein the energy and transport equations comprise Navier-Stokes equations.

27. The method of claim 22 wherein the rock data is based on at least one of geologic model data, log data and any combination thereof.

28. The method of claim 22 further comprising comparing the rock data within the mesh with at least one of geologic model data, log data and any combination thereof.

29. The method of claim 22 wherein the boundary conditions are based on at least one of well test data, modular dynamic tester data, reservoir simulator data and any combination thereof.

30. The method of claim 22 further comprising comparing the boundary conditions within the wellbore model to at least one of well test data, modular dynamic tester data, reservoir simulator data and any combination thereof.

31. The method of claim 22 further comprising generating type curve analogues from the simulations of the at least one production scenario with the wellbore model.

32. A modeling system for a wellbore completion comprising:
a processor;
a memory coupled to the processor; and
a set of computer readable instructions accessible by the processor, wherein the set of computer readable instructions are configured to:
construct a geometrical representation of a wellbore completion comprising downhole instrumentation;
discretize the geometrical representation of the wellbore completion into a mesh representing the wellbore completion;
populate the mesh with rock data;
obtain boundary conditions for the populated mesh to form the wellbore model; and
simulate at least one production scenario with the wellbore model to create a simulated production profile.

33. The modeling system of claim 32 wherein the mesh provides a framework to model countercurrent flow between an annulus and tubing in the wellbore completion.

34. The modeling system of claim 32 wherein the set of computer readable instructions is further configured to solve energy and transport equations in each of a plurality of cells in the mesh.

35. The modeling system of claim 34 wherein the energy and transport equations model at least one of radial convective heat transfer, radial conductive heat transfer, axial convective heat transfer, axial conductive heat transfer and fluid flow within the well along with a region surrounding the well.

36. The modeling system of claim 34 wherein the energy and transport equations comprise Navier-Stokes equations.

37. The modeling system of claim 32 wherein the rock data is based on at least one of geologic model data, log data and any combination thereof.

38. The modeling system of claim 32 the set of computer readable instructions is further configured to compare the rock data within the mesh with at least one of geologic model data, log data and any combination thereof.

39. The modeling system of claim 32 wherein the boundary conditions are based on at least one of well test data, modular dynamic tester data, reservoir simulator data and any combination thereof.

40. A method of managing a well completion comprising:
obtaining a wellbore model of a completion;
obtaining at least one simulated production profile generated from the wellbore model, wherein the at least one simulated production profile comprises at least two of pressures associated to depth, temperatures associated to depth, flow rates associated to depth, fluid flow velocities associated to depth, and any combination thereof;
disposing the completion and at least one sensor into a well;
obtaining sensory data from at least one sensor associated with the completion;
examining the sensory data to determine if production conditions have changed;
if the production conditions have changed, generating at least one measured production profile from the sensory data, comparing the at least one measured production profile to the at least one simulated production profile to determine a modification to the completion, and modifying the completion based of the determination; and
if the production conditions have not changed, continuing to operate the well.
